(19) United States
(12) Patent Application Publication
(10) Pub. No.: US 2015/0003580 A1
(43) Pub. Date: Jan. 1, 2015

(54) ASSEMBLY OF XRD/XRF SAMPLE CELLS

(71) Applicants: Philippe Christian Sarrazin, Sunnyvale, CA (US); Will M. Brunner, Scott's Valley, CA (US); Sunil Ranganath Belligundu, San Jose, CA (US)

(72) Inventors: Philippe Christian Sarrazin, Sunnyvale, CA (US); Will M. Brunner, Scott's Valley, CA (US); Sunil Ranganath Belligundu, San Jose, CA (US)

(73) Assignee: Olympus Scientific Solutions of America, Inc., Waltham, MA (US)

(21) Appl. No.: 14/313,411

(22) Filed: Jun. 24, 2014

Related U.S. Application Data
(60) Provisional application No. 61/840,151, filed on Jun. 27, 2013.

(51) Int. Cl. G01N 23/20; B29C 59/02; G01N 23/22

(52) U.S. Cl. CPC G01N 23/20025; G01N 23/2204; G01N 23/2206; B29C 59/02
USPC 378/44; 378/208; 378/79; 425/385

(57) ABSTRACT

Sample cell assemblies containing and holding powdered, granular, paste, or liquid samples are assembled and manufactured in a way that allows them to be inexpensive enough to be disposable and configured to be attached to a fork member for providing shaking or vibrating movement to the samples for X-ray Diffraction and X-ray Fluorescence testing. The sample cell assemblies include the usage of double-sided adhesive films and spacer for sealing the component of the sample cell assemblies, and latches as locking means for locking and unlocking the cell assemblies.

### RELATED APPLICATIONS

This application claims benefit of and priority to U.S. Provisional Application entitled “IMPROVEMENTS TO AN ASSEMBLY OF XRD/XRF SAMPLE CELLS” with application Ser. No. 61/840,151 filed Jun. 27, 2013 under 35 U.S.C. §119, 120, 363, 365, or 37 C.F.R. §1.55 or §1.78 incorporated herein by this reference.

### FIELD OF THE INVENTION

The present invention relates to a sample cell assembly for containing and holding powdered, granular, paste or liquid samples, configured to be attached to a fork-like member for proving shaking or vibrating movements to the samples for X-ray Diffraction (XRD) or X-ray Fluorescence (XRF) testing, specifically, to a sample cell assembly assembled and manufactured in a way that allows it to be inexpensive enough to be disposable.

### BACKGROUND OF THE INVENTION

In the present disclosure the XRD/XRF sample cells are assembled or manufactured to operate with a balanced mechanical resonator for a powder handling device disclosed in U.S. Pat. No. 8,302,477 (later as '477) issued to Sarrazin et al. The purpose of the balanced mechanical resonator is to provide a system and method for vibrating a sample composed of granular material to generate motion of the powder sample inside the sample holder without the transfer of the vibrations to the structure to which the sample holder is mounted. This provides random and uniform opportunity for all facets of all the sample particles to be facing the X-ray radiation energy.

One drawback found while using the sample cells of '477 was that the method with which they are manufactured makes them to be so expensive to prevent them to be disposable.

Among many other reasons, the sample cells of '477 are designed to be manufactured using metal, which makes them expensive to produce.

In addition, the existing XRD/XRF cells according to '477 uses pre-manufactured thin polymer films that were then bonded to a frame, or captured using a locking ring, in a procedure processing one cell at a time.

More parts and steps in the manufacturing process as well as the materials used in the manufacturing process can make the cost of making these sample cells higher than it needs to be. This prevents the user from disposing of the sample cell after use because it is not economically viable to purchase a new sample cell whenever you use a powder handling device.

Another U.S. Pat. No. 7,113,265 which was referenced as prior art in '477 discloses a powder handling device for analytical instruments which causes a powder sample in a sample holder to undergo vibration, rotation or translation. The sample holder of that invention appears to be formed as an integral part of the device and since it is an integral part the sample cell holder is not disposable. Therefore the material used to manufacture those sample cell holders is most likely expensive, although there is no mention of the material or method used to manufacture them.

Disposing of sample cells after their use is highly desirable in preventing sample cross-contamination due to residual powder or other such contaminants. It is beneficial, therefore, to have the sample cells to be inexpensive to manufacture. That way after an XRD or XRF test has been conducted on a sample the sample cell can be disposed of and replaced with a new one without incurring the high cost.

Therefore it would be advantageous to develop a sample cell manufactured out of less expensive material.

It would also be advantageous to develop a way to attach the parts of the sample cell together without the use of screws.

It would also be advantageous to develop a method for producing the film and frame of the sample cell in one step in large quantity in order to eliminate the individual bonding step.

These improvements would allow for the sample cells to be more inexpensively mass-produced.

### SUMMARY OF THE INVENTION

Disclosed is a disposable sample cell assembly for containing grain or powder samples, configured to attach to a fork member, which provides shaking or vibrating to the sample body.

One of the novel aspects and objectives of the present invention includes configuring sample cells for XRD/XRF analysis for them to be able to be fabricated in some type of a plastic molding process, such as plastic injection or transfer molding.

Another novel aspect is to employ a method of attaching the film using a heat seal or forming the film as an integral part of cell top or bottom using a hot embossing technique. This hot embossing technique differs from the traditional techniques, wherein a hot die is introduced to a polymer substrate, in that it relies on the fluid forces of the substrate to align the dies. This allows production of very thin (6 micron) wide (10 mm) films as one piece with their corresponding supporting frame.

The novel aspects also include the use of adhesiveness on both sides of the spacers hold the cell top to the cell bottom as well as providing a space for containing samples.

### BRIEF DESCRIPTION OF THE DRAWINGS

FIG. 1 is a perspective view of an XRD and/or an XRF sample cell assembly with samples cells attached to two arms of a fork member.

FIG. 2 is a schematic view of sample cell assembly for containing and holding powdered, granular, paste, or liquid samples for XRD testing.

FIG. 3 is a schematic view sample cell assembly for containing and holding powdered, granular, paste, or liquid samples for XRF testing.

FIG. 4 is a perspective view of a of an XRD sample cell assembly with an alternative locking mechanism.

FIGS. 5a, 5b and 5c are exhibition of the XRD sample cell shown in FIG. 4 with top, side and cross-sectional views.

FIG. 6 is a cross-sectional view showing a hot embossing technique where the formation of the plastic material is in an unaligned state.

FIG. 7 shows a hot embossing technique where the formation of the plastic material is in an aligned state.

### DETAILED DESCRIPTION OF EMBODIMENTS OF THE INVENTION

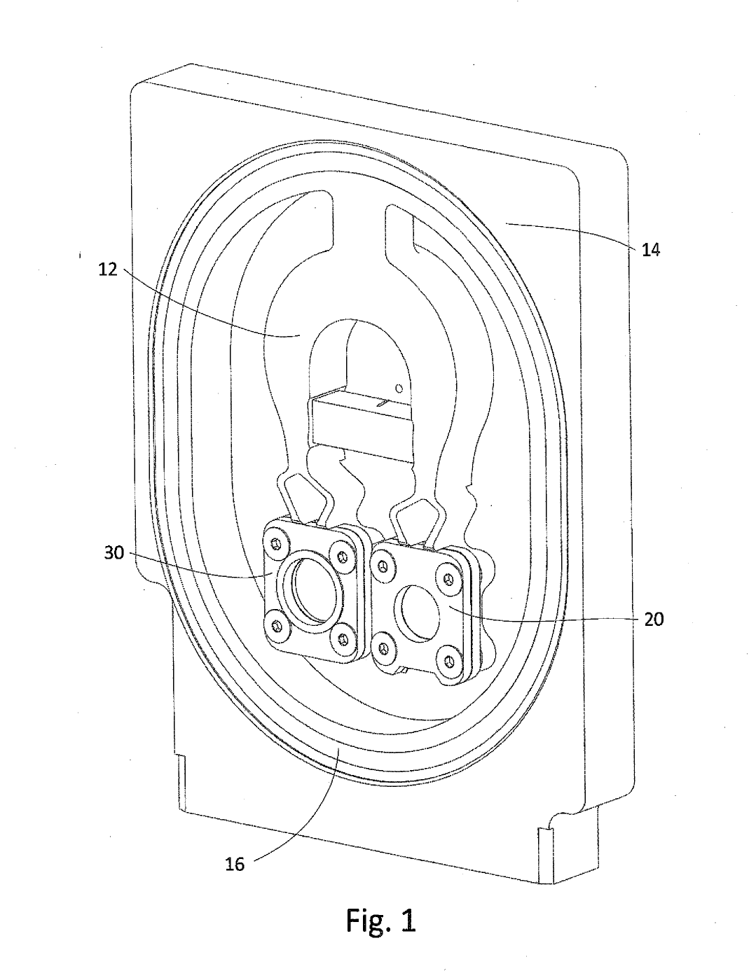

According to the present disclosure, FIG. 1 shows an exemplary way of how an XRD sample cell assembly 20 and a XRF sample cell assembly 30 is configured to be attached to a fork member 12 as part of a sample holder 14 for an XRD/XRF analytical system. The design of the fork member 12 is disclosed in '477, with both XRD sample cells attached. In the present disclosure, different sample cells, one of XRD 20 and one of XRF 30 are attached. Each of the sample cells 20 and 30 is configured to be independently coupled to and serving for independent XRD and XRF analysis, respectively. The sample cell assembly, including cells 20 and 30 and the fork member 12, is encircled by a seal 16 in part to form a gas envelope (not shown) to keep ambient air out and to allow purging of the cells with other gasses, such as helium. Seal 16 can be coupled with an encasing structure, formed by part of the analytical head of the XRD/XRF apparatus. The other components of the gas envelope are the sample holder 14, as well as an optionally barrier which could be a printed circuit board (not shown) used for the electronic function of the XRF/XRD device.

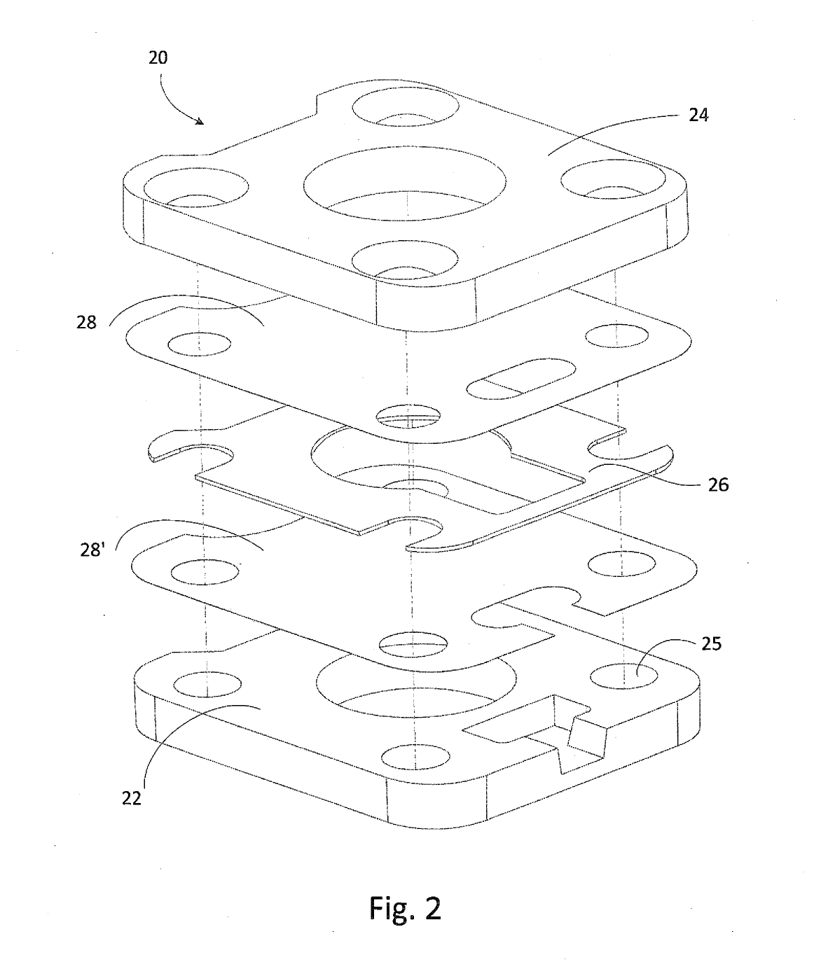

Referring now to FIG. 2, XRD sample cell assembly 20 is comprised of a cell top 24, forming the top enclosing part of XRD sample cell assembly 20, a cell bottom 22, forming the bottom enclosing part of XRD sample cell assembly 20, and a spacer 26 is place between cell top 24 and cell bottom 22, which seals cell top 24 to cell bottom 22. A pair of films 28 and 28′ is set in the center of cell top 24 and cell bottom 22 respectively.

One of the novel aspects of this invention is that cell top 24 and cell bottom 22 are able to be fabricated using large scale and in-expensive process and material. Preferably, cell top 24 and cell bottom 22 are fabricated using a plastic injection molding process out of a plastic material. Polyester is the optimal plastic for XRD testing. The cost for fabricating cell top 24 and cell bottom 22 are decreased when using plastic as opposed to metal, making the sample cell according to the present disclosure less expensive to manufacture.

Another novel aspect is that spacer 26 is configured to have adhesive material applied to both side of it. It can be made of laser or die cut from double sided thin material, such as sheet or tape to fit in between cell top 24, and cell bottom 22 and to not block the space between film 28 and 28′. Double sided tape or sheet allows spacer 26 to both provide a space between cell top 24 and cell bottom 22 for containing the sample and attach and seal cell top 24 to cell bottom 22. The use of double sided adhesive tape or sheet functions to seal the cell assemble in a simple fashion. In addition, the use of double sided adhesive tape or sheet eliminates the need for screws, in some design, eliminating more parts and more steps from the manufacturing process.

Continuing with FIG. 2, screw fasteners (not shown) can also be used for added integrity of sample cell 20 and 30. Screw holes, such as 25 is machined or molded on the corresponding parts.

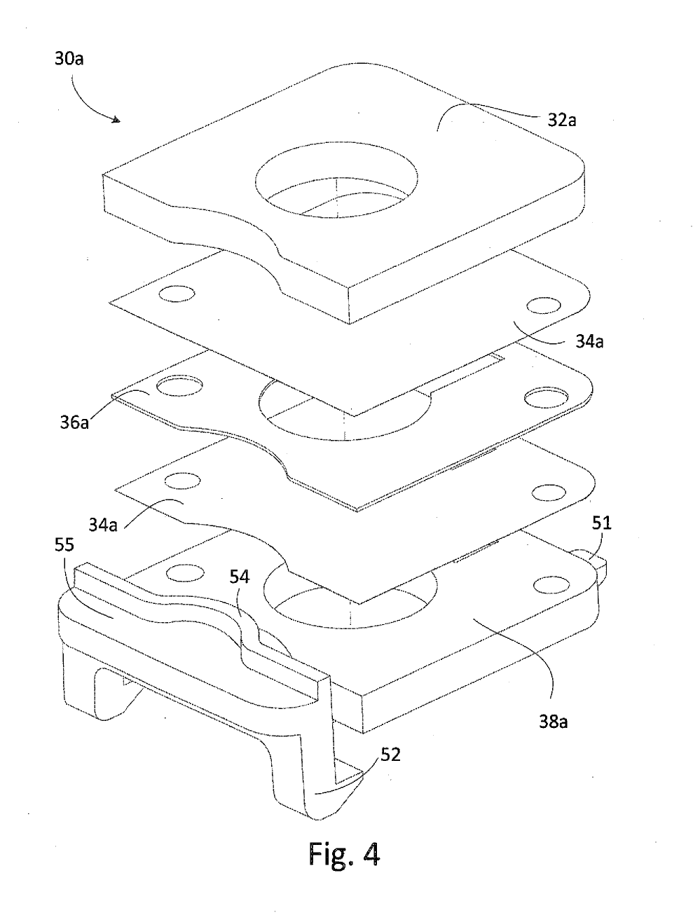

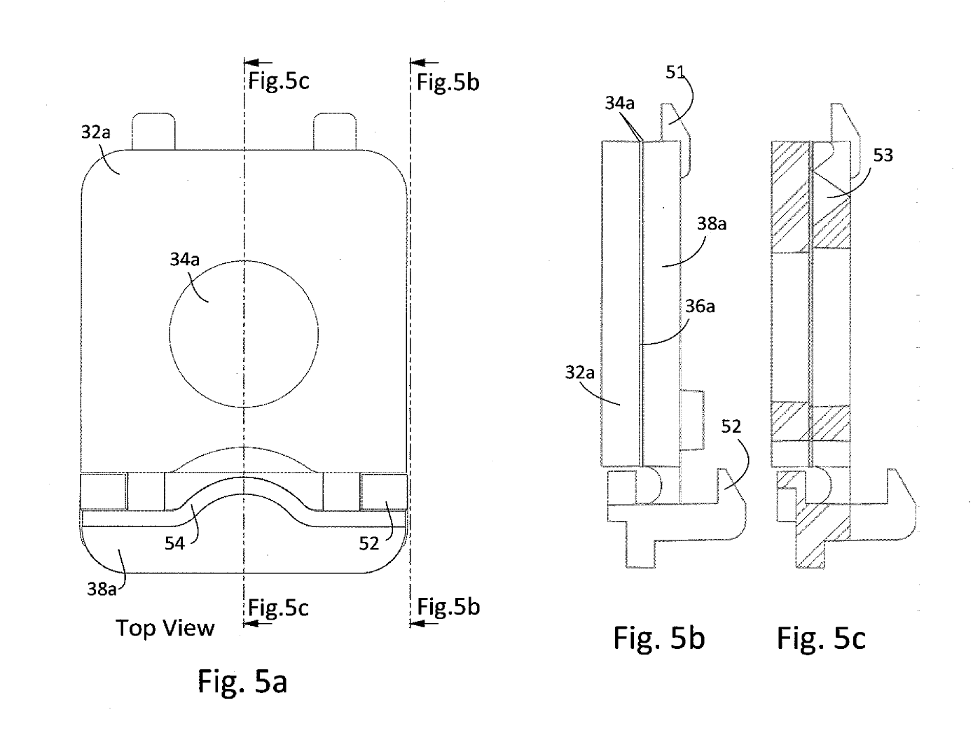

Yet another novel aspect is that film 28 and 28′ are made of the same type of plastic material as cell top 24 and cell bottom 22 and is stretched and heat sealed onto cell top 24 and cell bottom 22 (a process already known to those skilled in the art). Or in an alternative embodiment, film 28 can be formed as an integral part of cell top 24 or cell bottom 22 using a novel “hot embossing” technique (details shown in FIGS. 4 and 5). This technique allows for manufacturing a complete cell half as one integral part, eliminating the bonding step, and making manufacturing much less labor intensive.

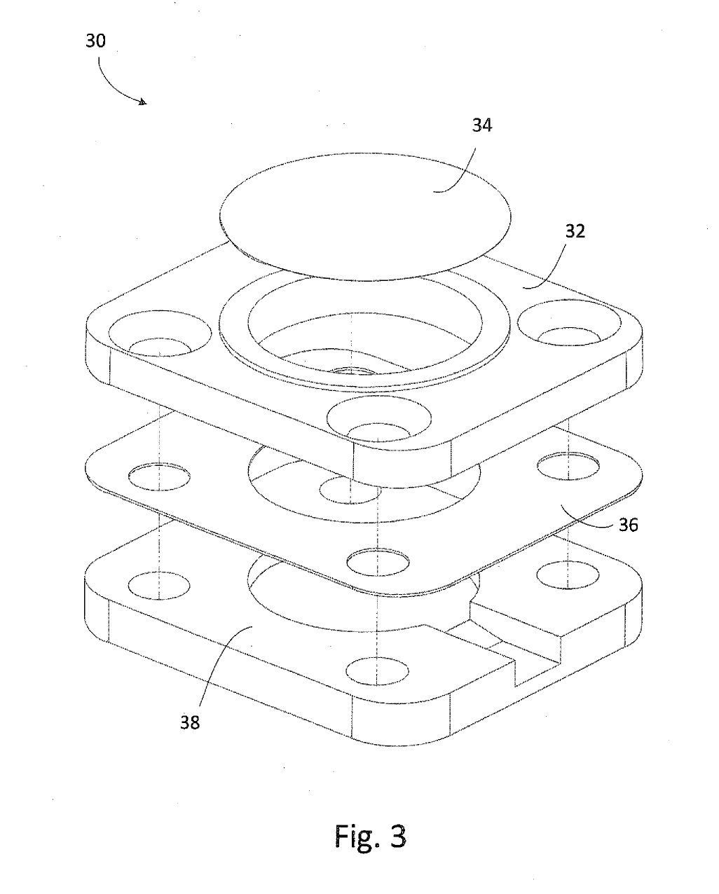

Referring to FIG. 3, XRF sample cell assembly 30 is comprised of a cell top 32, forming the top enclosing part of XRF sample cell assembly 30, a cell bottom 38, forming the bottom enclosing part of XRF sample cell assembly 30, and a spacer 36 is placed between cell top 32 and cell bottom 38, which connects cell top 34 to cell bottom 32. A film 34 is set in the center of and on the top surface of cell top 32.

It is a novel aspect of this invention that cell top 32 and cell bottom 38 of XRF sample cell assembly 30 are able to be fabricated using some time of plastic molding process out of a plastic material to reduce cost of manufacturing. Polypropylene is the optimal plastic for XRF testing. The cost for fabricating cell top 32 and cell bottom 38 are decreased when using plastic as opposed to metal, making this invention less expensive to manufacture.

Another novel aspect is that spacer 36 is configured to have adhesive material applied to both sides of it. It can be laser or die cut from double sided thin material such as sheet or tape to be fit in between cell top 32 and cell bottom 38 and to not block the space between film 34 and cell bottom 38. Spacer 36 provides a space for containing samples and attaches and seals cell top 32 to cell bottom 38. The use of double sided sheet or tape eliminates the need for screws, eliminating more parts and more steps from the manufacturing process.

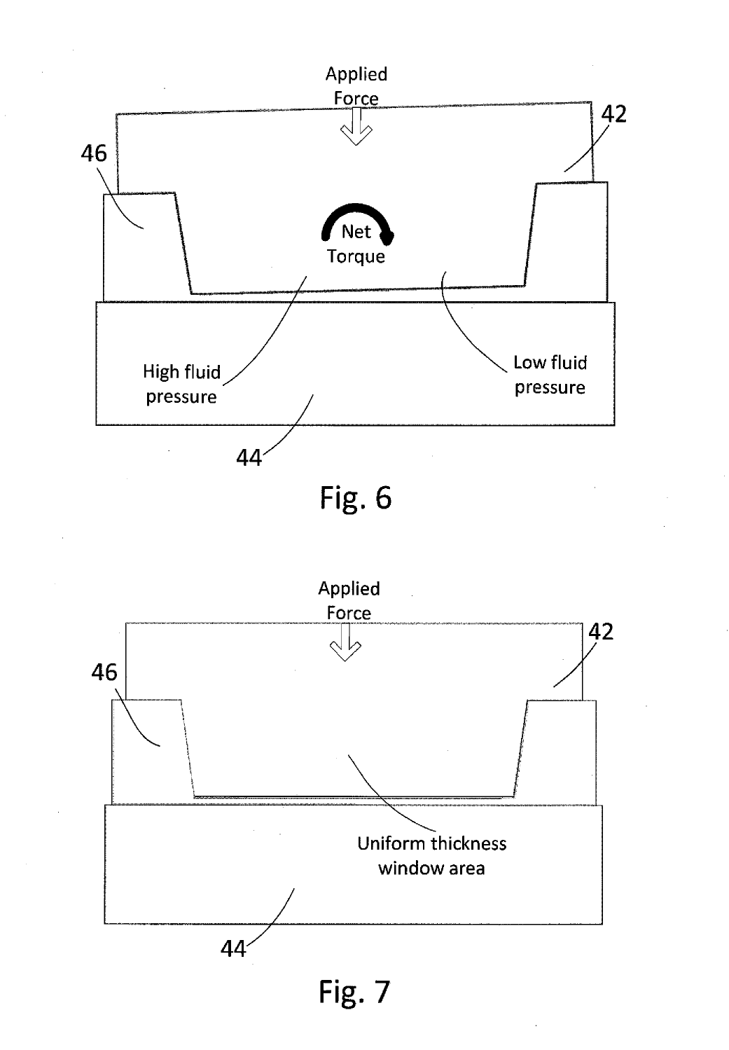

Similar to that of sample cell 20, yet another novel aspect of cell 30 is that film 34 is made of the same plastic material as cell top 32 and cell bottom 38 and is stretched and heat sealed onto cell top 32 (a process already known to those skilled in the art). Or in an alternative embodiment, it can be formed as an integral part of cell top 32 by employing a novel “hot embossing” technique (details shown in FIGS. 6 and 7). This technique allows for the manufacturing a complete cell half as one part, eliminating the bonding step, which makes manufacturing much less labor intensive.

Reference is now made to FIGS. 4, exhibiting a lower half of a sample cell 30a for XRD with an alternative locking mechanism. In connection with Figs, 5a, 5b and 5c, similar to sample cell 30, sample cell 30a comprises a cell top 32a, forming the top enclosing part of XRD sample cell assembly 30a, a cell bottom 38a, forming the bottom enclosing part of XRD sample cell assembly 30a, and a spacer 36a placed between cell top 32a and cell bottom 38a, which connects cell top 34a to cell bottom 32a. A film 34a is set in the bottom of cell top 32a and on the top surface of cell bottom 38a. The difference between sample cell 30a and 30 is that cell 30a utilizes a locking mechanism which embodies at least one pressure fitting latch 52, a handle bar 55, preferably with a finger rest 54. The locking mechanism with latch 52 greatly improves the productivity by eliminating the need of dealing with screws for opening and closing the cell assembly.

Also shown in FIGS. 4, 5a, 5b and 5c is an alternative sample loading inlet 53 with an opening into the cell chamber. Further alternatively, an alignment guide 51 is designed to easy the alignment of sample cell to fork member 12 shown in FIG. 1.

Reference is now made to FIG. 6 which exhibits a novel hot embossing machinery assembly 40 employed in the present disclosure as the alternative method of affixing films (28, 28′in FIGS. 2 and 34 in FIG. 3) onto cell top or bottom for either XRF or XRD cases.

As seen in FIG. 6, in an exemplary embodiment, the hot embossing machinery assembly 40 comprises a pressing member 48 (such as a hydraulic or pneumatic press), a universal joint or pad 46 (such as a ball-bearing type joint or a rubber like pad such as silicon pad, a heated top die 42, a heated bottom die 44, and a plastic material being formed into any one of the sample cell halves such as cell tops or cell bottoms (previously described as 22, 24, 32 or 38) with the films formed as an integral part of the cell halves.

Using cell top 24 as an example, during its fabrication process, a piece of plastic material is pressed down by pressing member 48 between heated top die 42 and bottom die 44, the center portion of the plastic material becomes thinner and is effectively formed into film 28 or 28′. A novel aspect of hot embossing machinery assembly 40 is that top die 42 is attached to pressing member 48 via a universal joint or pad 46, allowing freedom of movement of top die 42 in all directions, except moving along the center line or moving away from of the centerline of die 42. In other words, top die 42 is free to move peripherally up or down in responding to the viscous liquid pressure when die 42 is pressed down by pressing member 48 toward die 44. In comparison to existing hot embossing technique, top dies are rigidly attached to die machines and do not have freedom of movement in all direction.

Continuing with FIG. 6, heated top die 42 experiences a torque due to viscous forces in the plastic that tends to align it with heated bottom die 44. This is due to a physical phenomenon that, within the same liquid body, the thinner the film is, the higher the pressure exerted to pressing member 48 or heated top die 42 is. The novel aspect is that heated top die 42 is allowed to wiggle on universal joint or pad 46. FIG. 4 shows heated top die 42 and heated bottom die 44 in an unparalleled state, but subjected to a net torque attributing to the difference in the thickness of fluid (either melted plastic or that above the glass transition temperature) layer between a high fluid pressure and a low fluid pressure.

Subsequently, the allowed freedom of movement of top die 44 and the force of torque naturally evens out the thickness of the melted plastic which forms a uniform and thin layer of film 28, integral to cell top 24 as shown in FIG. 7.

This technique allows one to manufacture a complete cell half as one integral part, eliminating the film bonding step. It would also allow the manufacturing of very thin (6 micron) wide (10 mm) films as one piece with their supporting frame.

What is claimed is:

1. A sample cell assembly for containing and holding powdered, granular, paste or liquid samples for X-ray analysis of the samples, the sample cell assembly is configured to be attached to a fork member for providing shaking or vibrating movement to the samples, the sample cell assembly comprises, a cell top configured to form the top enclosing part of the cell assembly, a cell bottom configured to form the bottom enclosing part of the cell assembly, a spacer configured for providing a space for containing samples, wherein both sides of the spacer having adhesive material to form a seal with the cell top and bottom, and,
wherein there is at least one opening on the cell top and/or the cell bottom, the opening is covered with a film made of plastic material attached to the cell top or bottom to allow X-ray and responding energy to go through.

2. The sample cell assembly of claim 1, in which the cell top and cell bottom are fabricated by a plastic molding process.

3. The sample cell assembly of claim 1, in which the spacer is laser or die cut from double sided tape.

4. The sample cell assembly of claim 1, in which the film is stretched and heat sealed onto the corresponding plastic cell top or bottom.

5. The sample cell assembly of claim 1, in which the film is formed as an integral part of the cell top or bottom using a hot embossing technique.

6. The sample cell assembly of claim 1, in which the sample cell assembly is used for XRD testing.

7. The sample cell assembly of claim 1, in which the sample cell assembly is used for XRF testing

8. The sample cell assembly of claim 6, in which the plastic material is polyester.

9. The sample cell assembly of claim 7, in which the plastic material is polypropylene.

10. The sample cell assembly of claim 1 further comprises a latch like locking member configured to have a locked and unlocked position, locking the cell top and the cell bottom when it is at the locked position.

11. The sample cell assembly of claim 10, wherein the locking member including at least one pressure-fit latch.

12. The sample cell assembly of claim 10, wherein the locking member having a root portion of the latch to be molded directly onto one of the cell top or the cell bottom, where a tip portion of the latch is configured to be latched onto the cell bottom or cell top, correspondingly.

13. The sample cell assembly of claim 1, wherein the cell bottom having an opening for loading and/or unloading samples.

14. A balanced mechanical resonator assembly holding sample cells for XRD/XRF analysis, the resonator assembly comprising,
at least two sample cells, with at least one used to hold samples for XRF analysis, and at least one cell used to hold samples for XRD analysis,
a fork member having at least two fork tines, each of which holding one of the sample cell to provide shaking or vibrating movement to the samples,
a seal member encircling the fork member and all the cells for keeping ambient air out and purging sample cells with other gasses,
an encasing member that functions as a printed circuit board for electric functions servicing the XRD/XRF analysis.

15. The mechanical resonator assembly of claim 14, wherein each of the sample cells further comprising a cell top configured to form the top enclosing part of the cell assembly, a cell bottom configured to form the bottom enclosing part of the cell assembly, a spacer configured for providing a space for containing samples, wherein both sides of the spacer having adhesive material to form a seal with the cell top and bottom, and,
wherein there is at least one opening on the cell top and/or the cell bottom, the opening is covered with a film made of plastic material attached to the cell top or bottom to allow X-ray and responding energy to go through.

16. The mechanical resonator assembly of claim 14, in which the cell top and cell bottom are fabricated by a plastic molding process.

17. The mechanical resonator assembly of claim 14, in which the film is stretched and heat sealed onto the corresponding plastic cell top or bottom.

18. The mechanical resonator assembly of claim 14 further comprises a latch like locking member configured to have a locked and unlocked position, locking the cell top and the cell bottom when it is at the locked position.

19. A hot embossing machinery assembly for creating sample cell top or bottom of claim 1 with integral films, the hot embossing machinery assembly comprises
a pressing member,
a heated top die,
a heated bottom die,
a plastic material to be formed into the cell top or bottom is filled in and pressed between the heated top die and the heated bottom die, wherein the plastic material becomes a thin layer of viscous fluid when pressed,
a universal joint or pad which is coupled with the pressing member and the heated top die, transferring force from the pressing member to the top die while allowing the top die the freedom of movement to tilt around the joint when it experiences a torque force from the pressure of the viscous fluid that aligns the heated top die to be substantially parallel to the heated bottom die so that the plastic material becomes a film with even a thin, even thickness.

20. The hot embossing machinery assembly of claim 11, in which the pressing member is a hydraulic press.

21. The hot embossing machinery assembly of claim 11, in which the pressing member is a pneumatic press.

22. The hot embossing machinery assembly of claim 11, in which the universal joint is a ball-bearing type joint.
